(19) United States
(12) Patent Application Publication
(10) Pub. No.: US 2001/0055664 A1
(43) Pub. Date: Dec. 27, 2001

(54) Electronic component and method for etching an insulating layer of a component

(76) Inventors: Manfred Engelhardt, Feldkirchen-Westerham (DE); Volker Weinrich, Paris (FR)

Correspondence Address: LERNER & GREENBERG, P.A., Post Office Box 2480, Hollywood, FL, 33022-2480, US

(21) Appl. No.: 09/871,012

(22) Filed: May 31, 2001

(30) Foreign Application Priority Data
May 31, 2000 (DE) 100 27 932.5

(51) Int. Cl. H01B 13/00; B32B 3/10

(52) U.S. Cl. 428/138; 216/17

(57) ABSTRACT

A method for etching an insulating layer of an electronic or microelectronic component uses a catalyst that is present during the etching. The method is in particular used for etching oxides. The catalyst may be added in a gaseous form and/or as an intermediate layer in the component. A component having structures etched in a dielectric material, in which traces of an etching catalyst are detectable in and/or around a contact hole and/or the structures is also provided.

### BACKGROUND OF THE INVENTION

1. Field of the Invention:

The invention relates to a method for etching an insulating layer of an electronic or microelectronic component, in particular to a method for etching an oxide using a catalyst.

During the fabrication of electronic or microelectronic components, it is necessary to form deep structures such as deep hole structures and/or so-called contact holes which are inter alia used for the interconnects.

Since the integration level of components is rising continuously, and consequently, at the same time, the lateral extents are being continuously reduced, evermore complex and closely packed structures are produced. Therefore evermore accurate and reliable etching methods are required in order to achieve complicated structures within a very small space.

As the integration level increases, the aspect ratio (ratio of the depth of the contact hole to its diameter) increases. However, the etching rates at the same time decrease drastically, so that there is a search for techniques which counteract the drastic decrease or reduction of the etching rates as the aspect ratio increases.

Etching methods are known, for example from U.S. Pat. No. 5, 653, 851, in which an increasing reduction in the etching rate with increasing aspect ratio, i.e. with increasing depth of the structure to be etched, is simply accepted. The likelihood of ions or excited neutral species, which carry out the etching process, coming into contact with the surface to be etched becomes ever lower, since in some cases they rebound from the inner surfaces of the etched structure and are diverted in a different direction, thus losing their energy.

### SUMMARY OF THE INVENTION

It is accordingly an object of the invention to provide an etching method which overcomes the above-mentioned disadvantages of the heretofore-known etching methods of this general type and which has an increased etching rate, in particular during the etching of an insulating layer, which has an the etching rate that decreases more slowly, remains constant or even rises when the aspects ratio increases and/or the etching depth increases.

The invention relates to a method for etching an insulating layer, in which a catalyst is present before and/or during the etching. The invention also relates to a component having at least one contact hole and/or a deep structure, in which traces of an etching catalyst are detectable in and/or around this structure.

In other words, with the foregoing and other objects in view there is provided, in accordance with the invention, an electronic component configuration, including:

an electronic component formed with at least one structure selected from the group consisting of a contact hole and a deep structure; and

traces of an etching catalyst detectable at the at least one structure.

According to another feature of the invention, the electronic component is a microelectronic component.

According to yet another feature of the invention, the traces of the etching catalyst include a titanium-containing compound and/or titanium.

According to a further feature of the invention, the traces of the etching catalyst are detectable in the contact hole.

With the objects of the invention in view there is also provided, a method for etching an insulating layer, the method includes the steps of:

etching an insulating layer; and

performing the etching step such that a catalyst is present prior to and/or during the etching step.

According to another mode of the invention, the catalyst is applied to at least an inner surface of a structure to be etched prior to and/or during the etching step. In other words, the catalyst may be contained directly in the hole structure, for example on the inner surfaces of the hole and/or the trench. During the etching, the catalyst is present, at one location or at a plurality of locations, as a solid, in the gas phase and/or as a liquid additive.

According to a further mode of the invention, the catalyst is provided as a part of the insulating layer.

According to another mode, it is advantageous if the catalyst is present in the gas phase during the etching, i.e. if it is added in gaseous form. The quantity of the catalyst depends on the activity of the species employed, both with regard to the chemical compound and with regard to its physical state. For example, smaller quantities of a gaseous addition may be required compared to a solid addition, since in the solid state, by way of example, only the exposed surface is catalytically active.

According to a further mode of the invention, the catalyst is applied to partial regions of a wafer or substrate to be etched prior an/or during the etching step.

The catalyst is also, according to one embodiment, part of a component of the etching chamber, such as for example the process kit, the chamber liner and/or the shadow ring. During the etching process, the catalyst is released in sufficient quantities as a result of the operating temperature, the operating pressure of the plasma and the like, so that the etching rate is increased.

According to one embodiment, the catalyst is present on the wafer itself. In this case, the catalyst is, for example, already bound into the insulating layer which is to be etched. Alternatively, it may, for example, be introduced into the insulating layer in the form of at least one catalyst layer. The result is, for example, a dielectric with a sandwich structure in which there are one or more catalyst layers. As an alternative or in addition, a spacer made from catalyst material may be used in the insulating layer.

According to an advantageous embodiment, the catalyst is a titanium-containing compound, such as for example titanium nitride (TiN). In this case, the catalyst may be an individual substance or a mixture of a plurality of compounds.

The catalyst used is any substance whose presence leads to an increase in the etching rate during the etching. This also means a slowing in the drop of the etching rate, or a maintained and/or increased etching rate with an increasing aspect ratio and/or an increasing etching depth.

The “structure which is to be etched” is the insulating layer of a component, which is etched through in accordance with a predetermined mask, so that a free contact with a layer at a lower level becomes possible. The material of the insulating layer is, for example, a dielectric, such as silicon oxide or silicon nitride.

Other features which are considered as characteristic for the invention are set forth in the appended claims.

Although the invention is illustrated and described herein as embodied in an electric component and a method for etching an insulating layer of a component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, partial sectional view of a component according to the invention with a layer structure, wherein only the immediate vicinity of a hole structure is illustrated;

FIGS. 2a to 2f are diagrammatic, partial sectional views of a further component according to the invention with a layer structure, wherein only the immediate vicinity of a hole structure is illustrated.

### DESCRIPTION OF THE PREFERRED EMBODIMENTS

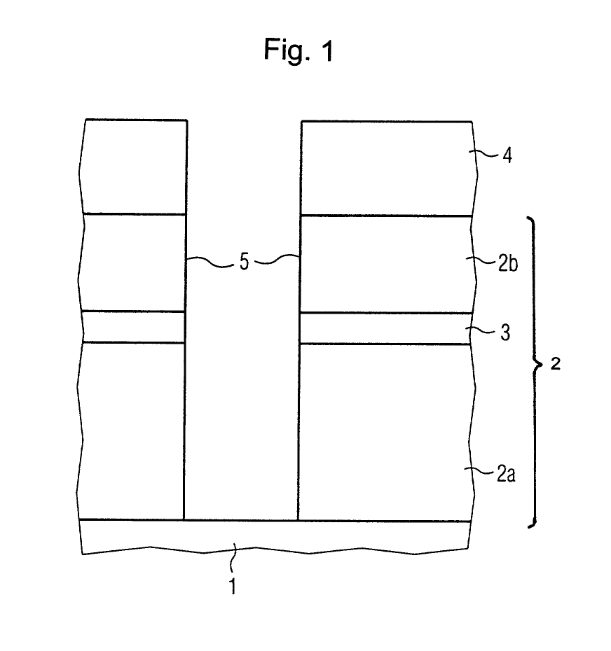

Referring now to the figures of the drawings in detail two embodiments of the invention are described. FIG. 1 shows a silicon substrate 1. A first insulating layer 2, for example of silicon oxide (SiO₂), has been applied to the substrate. Embedded in this layer is a thin layer 3 including catalyst material, such as for example a titanium-containing compound. The insulating layer 2 has accordingly a sandwich structure. A layer containing a photoresist 4, which predetermines the etching pattern, is applied to the top of the insulating layer 2. The extent of the structure which is to be etched is predetermined by the absence of photoresist and the depth is determined by the height of the insulating layer. At the location of the insulating layer 2 where the photoresist 4 is absent, the insulating layer 2 is to be etched through down to the substrate 1. At the beginning of etching, i.e. during the etching of the upper part of the insulating layer 2b, the etching rate is, for example, 500 nm/min. After the catalyst layer on the inner surface 5 of the structure to be etched has been exposed, the etching rate for the lower insulating layer 2a rises to over 800 nm/min. This is attributable to the activity of the catalyst.

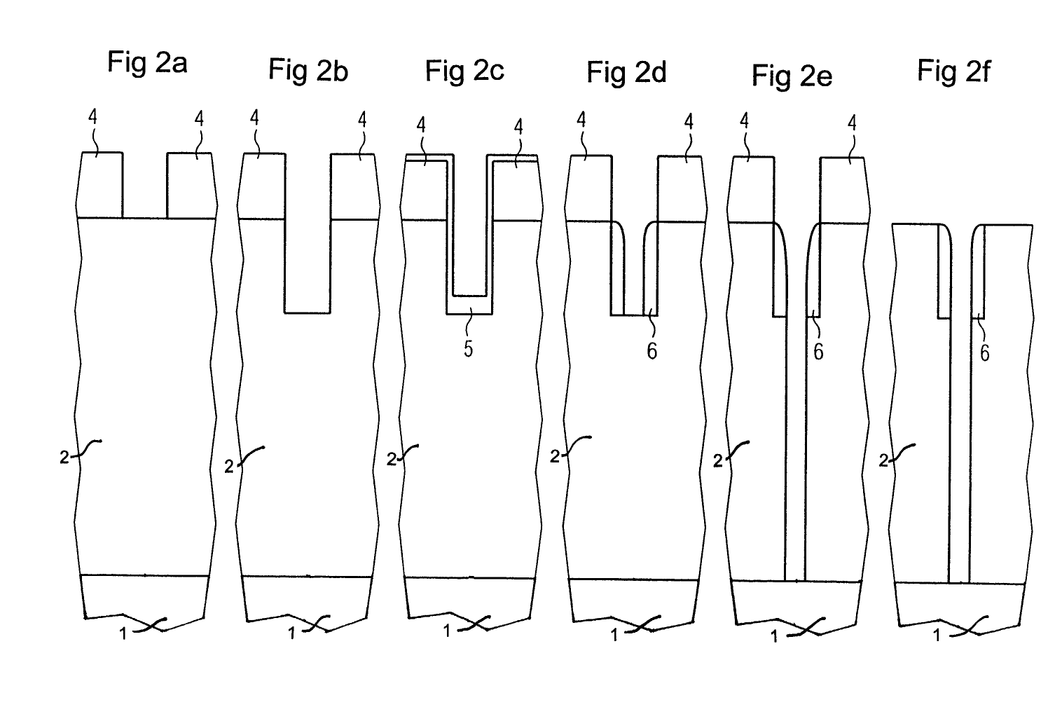

FIGS. 2a to 2f show the use of a catalyst spacer and show how the process proceeds. FIG. 2a shows, right at the bottom, the substrate 1, which is formed of, for example, monocrystalline silicon, on top of which a metal (e.g. aluminum), polysilicon and/or electrically insulating material is applied. Above this there is the insulating layer 2. The insulating layer 2 is followed by the structured mask 4, which may be formed of photoresist, polyimide, photoimide or the like. Also shown is the finished patterning mask 4 on the insulating layer 2, which is as yet completely unetched. FIG. 2a so far only shows a conventional structure. FIG. 2b also shows a conventional structure, showing the result of a partial etching of the insulating layer 2, which proceeds at a standard etching rate.

In FIG. 2c, according to this embodiment of the invention, a film 5 of catalyst material e.g. titanium nitride, has been applied to the surface of the partially etched insulating layer. The film is applied, for example, by sputtering or conventional coating techniques such as PVD (physical vapor deposition) and/or MOCVD (metal organic chemical vapor deposition).

As can be seen from FIG. 2d, this film is then structured by partial etching, which may be a spacer etching with overetching. The result, as can be seen in FIG. 2e, is a spacer 6 of catalyst material, with catalyst material only adhering to the inner surface of the structure which is to be etched. In this state, the complete etching of the insulating layer takes place, wherein the etching proceeds at higher etching rates than those achieved according to the prior art, as a result of the adhering catalyst.

FIG. 2f shows the finished etched structure, in which the mask has already been removed. In the exemplary embodiment, the catalyst spacer 6 remains in the etched structure, although it is also possible for the catalyst to be removed again from the insulating layer.

The invention has for the first time made it possible to increase the etching rate of the reactor used during the etching of the insulating layer of a component throughout the entire duration of the etching. This means that at least the drastic fall or decrease in the etching rate, which has hitherto been struggled with, can be reduced. The result is an improved utilization of the machines employed and an increased wafer throughput in the installations, particularly in cluster devices. This is made possible by the presence of a catalyst, which may be provided or incorporated in various locations, such as the wafer, the gas phase, chamber elements and may be present in various physical states. The invention also relates to a component with structures etched in a dielectric, in which traces of an etching catalyst are detectable in and/or around the contact hole and/or the structures.

We claim:

1. An electronic component configuration, comprising:
an electronic component formed with at least one structure selected from the group consisting of a contact hole and a deep structure; and
traces of an etching catalyst detectable at said at least one structure.

2. The electronic component configuration according to claim 1, wherein said electronic component is a microelectronic component.

3. The electronic component configuration according to claim 1, wherein said traces of said etching catalyst include at least one material selected from the group consisting of a titanium-containing compound and titanium.

4. The electronic component configuration according to claim 1, wherein said traces of said etching catalyst are detectable in said contact hole.

5. A method for etching an insulating layer, the method which comprises:
etching an insulating layer; and
performing the etching step such that a catalyst is present during at least one time period selected from the group consisting of a period prior to the etching step and a period during the etching step.

6. The method according to claim 5, which comprises applying the catalyst to at least an inner surface of a structure to be etched during at least one time period selected from the group consisting of a period prior to the etching step and a period during the etching step.

7. The method according to claim 5, which comprises providing the catalyst as a part of the insulating layer.

8. The method according to claim 6, which comprises providing the catalyst as a part of the insulating layer.

9. The method according to claim 5, which comprises using the catalyst as a spacer.

10. The method according to claim 5, which comprises adding the catalyst to a gas phase.

11. The method according to claim 5, which comprises applying the catalyst to partial regions of a wafer to be etched during at least one time period selected from the group consisting of a period prior to the etching step and a period during the etching step.

12. The method according to claim 5, which comprises applying the catalyst to partial regions of a substate to be etched during at least one time period selected from the group consisting of a period prior to the etching step and a period during the etching step.

13. The method according to claim 5, which comprises providing the catalyst as a part of an etching chamber.

14. The method according to claim 5, which comprises using a titanium compound as the catalyst.
